(19) United States
(12) Patent Application Publication
(10) Pub. No.: US 2025/0387917 A1
(43) Pub. Date: Dec. 25, 2025

(54) PALLETISATION AND DEPALLETISATION GRIPPER, SYSTEM AND METHOD

(71) Applicant: FIVES SYLEPS, Lorient (FR)

(72) Inventors: Thierry BOISNARD, Lorient (FR); Mircea COCAN, Lorient (FR)

(21) Appl. No.: 18/877,679

(22) PCT Filed: Jun. 21, 2023
(86) PCT No.: PCT/EP2023/066801

§ 371 Date: Dec. 20, 2024

(30) Foreign Application Priority Data
Jun. 23, 2022 (FR) FR2206250

(51) Int. Cl. B25J 9/16; B25J 15/00; B25J 15/06

(52) U.S. Cl. CPC B25J 9/1697; B25J 15/0052; B25J 15/0616

(57) ABSTRACT

A gripper intended to be mounted on a robot of a loading/unloading system in order to grip, when it is actuated, a package to be moved from or to a container, the gripper comprising a frame carrying a plurality of gripping devices each having a first end attached to the frame and a second end carrying a suction cup (303), the suction cup being connected to a vacuum device. In one aspect, each suction cup can be actuated individually to grip the package by suction; and a gripping device comprises a linear shaft that is movable with respect to the frame and can move the suction cup of the device between a retracted position and an advanced position. A parcel loading/unloading system using this gripper, as well as to a method of using the system is also disclosed.

### FIELD OF THE INVENTION

The invention belongs to the field of intralogistics and relates to a gripper and a palletization/depalletization system. It further relates to an automated parcel unloading method using such a system.

### STATE OF THE ART

Known palletization/depalletization systems use a robot to place or remove a set of packages in a certain order.

A package (or parcel) can be any type of regularly shaped object that can be transported in a container, for example in the form of a cubic or cuboid box, or in the form of a commodity, for example a set of bags or bottles held together by a plastic film.

A container can be, for example, a pallet, a roll cart, or a crate.

In known depalletization systems, a pallet comprising a set of packages arranged in superimposed layers is fed to the unloading station. A robot fitted with a gripper is configured to come into contact with a package to pick it up by suction, then move it to a receiving area such as a conveyor, and set it down. The gripper can also pick up more than one item at a time. This operation is often tricky when packages are of variable size, and when the system does not know in advance the dimensions of the packages to be unloaded. Vision and associated calculation systems estimate the time needed to pick up and set down packages, in order to limit the risk of impacts.

However, when a package is not presented in an ordinary position, e.g. tilted during loading or following the movement of the container, there is a risk of the package being damaged if the gripper used is an ordinary one. In this case, the method can be interrupted in order to manually pick up the tilted package or return it to a usual position, enabling the robot to continue loading or unloading.

It is therefore necessary to find an automatic solution to avoid taking the risk of damaging such packages arriving in a tilted position, or wasting precious time each time the system detects a package presented in an unusual position.

The aim of the present invention is therefore to provide a palletization and/or depalletization system that solves the problem described above.

### SUMMARY OF THE INVENTION

To this end, according to a first aspect, the invention relates to a gripper intended to be mounted on a robot of a loading/unloading system in order to grip, when it is actuated, a package to be moved from or to a container, said gripper comprising a frame carrying a plurality of gripping devices each having a first end attached to the frame and a second end carrying a suction cup the suction cup being connected to a vacuum device.

According to the invention:
each suction cup can be actuated individually to grip the package by suction, and
a gripping device comprises a linear shaft that is movable with respect to the frame and can move the suction cup of said gripping device between a retracted position and an advanced position.

Advantageously, two or more gripping devices comprise a respective movable linear shaft. In some embodiments, each gripping device comprises a movable linear shaft.

By moving one or more suction cups, it is possible to adapt the pick-up position of the gripper to the position of an tilted package.

Advantageously, the linear shaft may be a hollow cylinder (also called a plunger), for example in the form of a ball screw, with an upper end connected to the vacuum device and a lower end carrying the suction cup.

The hollow cylinder enables the fluidic connection to the vacuum device without the need for additional piping, thus reducing space requirements and maintenance, and increasing robustness.

Advantageously, the gripping device comprises a ball-and-socket joint connecting the suction cup to said cylinder.

Thanks to the ball-and-socket joint, the suction cup can adapt to the tilt of the package, ensuring a good grip by suction.

Advantageously, the gripping device comprises a straightening means configured to cooperate with the ball-and-socket joint to restore the position of the suction cup relative to the linear shaft. This enables the parcel to be straightened into a position that facilitates its placement on the container or receiving area. This also makes it possible to have suction cups with a regular orientation, e.g. horizontal, at least in the retracted position.

Advantageously, the gripping device may comprise an annular motor within which the linear shaft passes, said motor being configured to move said linear shaft to bring the suction cup from the retracted position to the advanced position and vice versa.

This makes for a compact gripper. That is because it requires no belt or gear transmission, which considerably reduces the space occupied by each gripping device.

Advantageously, the gripping device may comprise an encoder configured to measure the position of the linear shaft and transmit it to a control means external to the gripper.

This enables the control means to deduce the position of the suction cup in space and control its movement by the movement means, for example by the annular motor.

Advantageously, the gripping device may comprise a brake that can be controlled to lock the linear shaft in certain positions of the suction cup. For example, the brake can be activated to lock the linear shaft when the motor is not powered, to save energy and prevent motor overheating. The brake therefore secures the gripping device and the integrity of the parcels being moved.

The control means comprises, for example, an inverter able to drive the motor and receive information from the encoder, and also to control the brake.

Advantageously, the plurality of gripping devices can be arranged in two parallel rows that can be moved relative to each other so that the distance between them can be varied according to the size of the package to be gripped.

This makes it possible to adapt the pick-up action of the gripper along a first direction of the package, for example to adapt it to the width of the package. This also allows the second-row devices to be done away with if pick-up can be done with the first row alone.

Advantageously, a row may comprise two gripping devices separated by a distance that can be varied according to the dimensions of the package to be gripped.

This makes it possible to adapt the pick-up action of the gripper along a second direction, for example to adapt it to the length of the package. This also allows to separate the devices in the same row that are not involved in picking up the package.

The invention further relates to a loading or unloading system comprising a gripper as described above.

Advantageously, the loading/unloading system according to the invention as described above may further comprise vision means able to detect a tilted parcel and control means able to control the movement of at least one suction cup depending on the tilt of the parcel deduced from information transmitted by the vision means.

The invention also relates to a depalletization or palletization method in which packages are unloaded or loaded from a container using an unloading or loading system as described above.

### BRIEF DESCRIPTION OF THE FIGURES

Further features and advantages of the invention will become apparent from the following description in relation to the appended drawings, given as non-limiting examples, wherein:

FIG. 1 shows a robot equipped with a gripper according to a first exemplary embodiment of the invention;

FIG. 2 shows a robot equipped with a gripper according to a second embodiment;

FIG. 3 shows a gripping device as shown in FIG. 2 in its retracted and extended positions;

FIG. 4 shows a cross-sectional view of zone IV as shown in FIG. 3.

### DETAILED DESCRIPTION

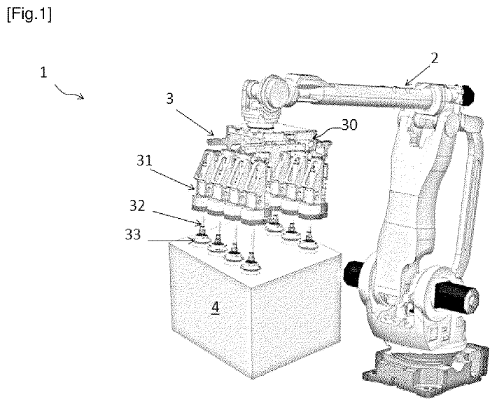

FIG. 1 partially depicts a system 1 for loading or unloading packages 4 according to a first embodiment of the invention. The system 1 comprises a robot 2 on which a gripper 3 according to the invention is mounted.

The container from which the package 4 is taken is not shown, but it may be, for example, a pallet or a roll cart. Such a container may comprise a set of packages 4, for example parcels, of heterogeneous shapes and sizes. They may also be partially or totally homogeneous. Some of the packages 4 are presented tilted, for example, as a result of being transported.

In this situation, a palletization/depalletization system of the type known from the prior art would have to be stopped to allow manual pick-up of the tilted packages, which is a considerable waste of time.

To solve this problem, the gripper 3 according to the invention as shown in FIG. 1 comprises a plurality of gripping devices 31 carried by a frame 30. By way of example, the number of gripping devices 31 may be 8 as shown in FIG. 1, but the number may be different in non-shown embodiments.

Each device 31 comprises a suction cup 33 connected to a vacuum device not shown in FIG. 1. The suction cup 33 is used to grip the parcel 4 or part of it by suction, as shown in FIG. 1. To enable gripping of a tilted parcel, as is the case for the parcel 4, the gripping devices 31 have linear shafts 32 which can be moved relative to the frame 30. For example, in FIG. 1, the 8 gripping devices 31 each comprise a movable linear shaft 32 capable of moving the respective suction cup 33 depending on the tilt of the parcel 4.

The linear shaft may be in the form of a tube or cylinder arranged to slide in order to move the suction cup 33 a given distance relative to the frame 30.

To control the gripper 3 and the gripping devices 31, the system 1 may, for example, comprise vision means capable of detecting the tilt of the package 4. The system may further comprise control means, such as software capable of processing the information received from the vision means and controlling the movement of the suction cups 33 depending on the determined tilt. The software can also control the movement of the parcel 4 after it has been gripped by the suction cups.

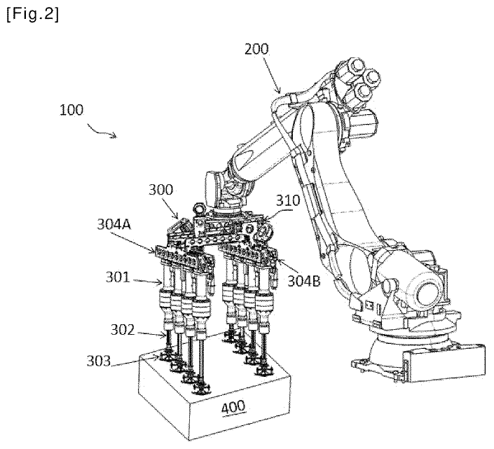

FIG. 2 shows a second example in which the loading/unloading system 100 comprises a robot 200 on which is mounted a gripper 300 comprising a frame 310 which carries gripping devices 301.

This loading/unloading system operates in a similar way to the system shown in FIG. 1.

As with the system 1 described above, the system 100 may comprise vision means capable of detecting the tilt of the package 400. The system 100 may further comprise control means, such as software capable of processing the information received from the vision means and controlling the movement of the suction cups 303 depending on the determined tilt. The software can also control the movement of the parcel after it has been gripped by the suction cups.

The special feature of the system 100 shown in FIG. 2 is that the gripper 300 is much more compact thanks to the shape of the gripping devices 301. Two ramps 304A, B are attached to the frame 310, each carrying a plurality of gripping devices 301, for example four of them.

Advantageously, the two ramps 304A, B can be moved relative to each other so that the distance between them can be varied according to the size of the package 400 to be gripped.

Advantageously, within the same row, at least two gripping devices 301 are separated by a distance that can be varied depending on the dimensions of the package to be gripped. For example, the ramp 304A can be controlled so that the distance between each two gripping devices 301 can be widened or narrowed.

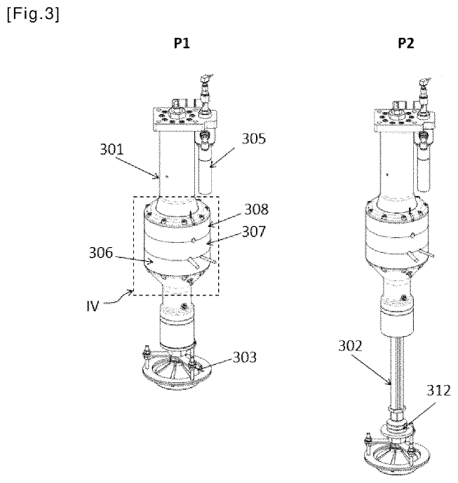

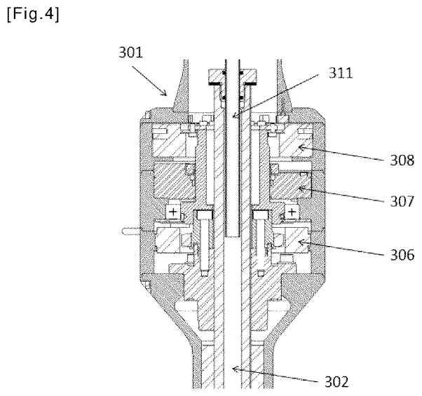

FIG. 3 shows a device 301 of the gripper 300 in the retracted position P1 and in the advanced position P2. FIG. 4 shows a cross-sectional view of zone IV as shown in FIG. 3.

As can be seen from the drawings, the gripping device 301 is compact and generally cylindrical. In the upper part, a hollow rod 311 is connected to the vacuum block 305 (called a venturi block); the tube providing the connection is not shown in FIG. 3. In the lower part, a linear shaft in the form of a hollow cylinder 302 can slide relative to the tube 311 without loss of sealing. The cylinder 302 (also known as a plunger) is, for example, a ball screw. The shaft 302 carries a suction cup 303 at the bottom. Advantageously, the suction cup 303 can be connected to the cylinder 302 by a ball-and-socket joint 312. This allows the position of the suction cup to be adapted to the tilt of the parcel 400.

Such a ball-and-socket joint can also be associated with the embodiment shown in FIG. 1.

In the central part, the gripping device 301 may comprise an annular motor 306 through which the linear shaft 302 (which in the example is a ball screw) passes. The motor can be driven to move the axis 302 to bring the suction cup from position P1 to position P2 and vice versa.

Compared with the previous example, this motor has the advantage of not requiring belt or gear transmission, which considerably reduces the space occupied by each gripping device 301. Thanks to this motor, the gripper is very compact.

The gripping device 301 may further comprise an encoder 307 and a brake 308, which are also annular in the example shown in FIGS. 2 to 4. The encoder enables the position of the linear shaft 302 to be measured at any time and transmitted to the control unit. The brake 308 can be controlled to lock the linear shaft in certain positions of the suction cup 303.

The control means comprises, for example, an inverter able to drive the motor and receive information from the encoder, and also to control the brake.

A loading or unloading cycle using the system described above may comprise some or all of the following steps:

A container, such as a pallet, is fed to a loading/unloading station by a conveyor.

The container is optionally placed on a lifting table.

A detection means detects the parcels located in the upper part and transmits the images to the control system;

The control system determines the uppermost parcel to be picked up first by the gripper;
The control device can select the number of gripping devices involved in picking up the parcel according to its dimensions.

The spacing between the gripping devices 301 can be adjusted according to the size of the package and the number of gripping devices 301 involved;

If the uppermost parcel is tilted, the control means controls the motor of one or more gripping devices 31, 301 to move the respective suction cup(s) in accordance with the tilt of the parcel;
The gripper descends to pick up the parcel, then rises again, and the suction cups are moved to the retracted position P1, so that the parcel is horizontal and ready to be moved to the receiving area.

These steps are repeated for all packages.

1. A gripper intended to be mounted on a robot of a loading/unloading system to grip when actuated a package to be moved from or to a container, said gripper comprising a chassis carrying a plurality of gripping devices each having a first end fixed to the chassis and a second end carrying a suction cup, said suction cup being connected to a vacuum device, in which:
each suction cup can be individually actuated to grip the package by suction, and
a gripping device comprises a linear axis movable relative to the chassis and capable of moving the suction cup of said gripping device between a retracted position and an advanced position, wherein the gripping device comprises an annular motor through which the linear axis passes, said motor being configured to move said linear axis to carry the suction cup from the retracted position to the advanced position and vice versa.

2. The gripper according to claim 1 in which the linear axis is a hollow cylinder having an upper end connected to the vacuum device and a lower end carrying the suction cup.

3. The gripper according to claim 2 wherein the gripping device comprises a ball joint connecting the suction cup to said cylinder.

4. The gripper according to claim 3, in which the gripping device comprises a straightening means configured to cooperate with the ball joint to restore the position of the suction cup relative to the linear axis.

5. The gripper according to claim 1, in which the gripping device comprises an encoder configured to measure the position of the linear axis and transmit it to a control means external to the gripper.

6. The gripper according to claim 1, in which the gripping device comprises a brake capable of being controlled to block the linear axis according to certain positions of the suction cup.

7. The gripper according to claim 1, in which the plurality of gripping devices is arranged in two parallel rows movable relative to each other so that the distance between them can be varied according to the size of the package to be gripped.

8. The gripper according to claim 7, in which a row comprises two gripping devices separated by a distance capable of being varied according to the dimensions of the package to be gripped.

9. A loading or unloading system comprising a gripper according to claim 1.

10. An unloading or loading system according to claim 9 further comprising a vision means capable of detecting an inclined package and control means capable of controlling the movement of at least one suction cup according to an inclination of said packet deduced from information transmitted by the vision means.

11. A depalletizing or palletizing method in which packages are unloaded or loaded from a container using an unloading or loading system according to claim 9.

12. A depalletizing or palletizing method in which packages are unloaded or loaded from a container using an unloading or loading system according to claim 10.
